(19) United States
(12) Patent Application Publication
(10) Pub. No.: US 2005/0011549 A1
(43) Pub. Date: Jan. 20, 2005

(54) Substrate for solar battery, and solar battery using same

(76) Inventor: Kozo Miyoshi, Kitamoto-shi (JP)

Correspondence Address: BACHMAN & LAPOINTE, P.C., 900 CHAPEL STREET, SUITE 1201, NEW HAVEN, CT, 06510, US

(21) Appl. No.: 10/886,470

(22) Filed: Jul. 6, 2004

(30) Foreign Application Priority Data
Jul. 9, 2003 (JP) 2003-194110

(51) Int. Cl. H02N 6/00

(52) U.S. Cl. 136/243

(57) ABSTRACT

On one side of a substrate 2 for a solar battery 1, a plurality of inclined surfaces 9A, 9B are formed so as to be inclined with respect to the plane of the substrate 2. On the plurality of inclined surfaces 9A, 9B, a photoelectric transfer layer 5 is formed so as to extend along the plurality of inclined surfaces 9A, 9B. On the other side of the substrate 2, a plurality of cylindrical lenses 8 are formed for receiving light beams to change the traveling directions of the received light beams toward one end portion of a corresponding one of the plurality of inclined surfaces 9A, 9B, the one end portion thereof being arranged on the inside in a direction perpendicular to the plane of the substrate 2. Each of the plurality of cylindrical lenses 8 allows at least part of the received light beams to be condensed on the surface of a portion of the photoelectric transfer layer 5 facing the one end portion of the corresponding one of the plurality of inclined surfaces 9A, 9B so as to travel in the photoelectric transfer layer 5.

### BACKGROUND OF THE INVENTION

1. Field of the Invention

The present invention generally relates to a substrate for a solar battery, and a solar battery using the same.

2. Description of the Prior Art

In recent years, solar batteries for converting light energy to electric energy have been widely noticed from the point of view of environmental issues. There are various solar batteries, such as silicon solar batteries, compound semiconductor solar batteries and organic solar batteries. In the present circumstances, solar batteries of the best kind with respect to all points, such as photoelectric transfer efficiency and production costs, have not been found, so that solar batteries are chosen according to the intended purpose.

In a typical solar battery, a first electrode film, a photoelectric transfer layer and a second electrode film are sequentially stacked on a substrate. For example, in a crystal silicon solar battery, a photoelectric transfer layer is arranged between positive and negative electrode films although the electrode films serve as substrates. In amorphous silicon solar batteries, incident light enters a transparent substrate or a transparent electrode in accordance with the construction of the substrate.

When incident light enters a transparent substrate, the incident light passing through the transparent substrate passes through a first electrode film to enter a photoelectric transfer layer. Then, photoelectric transfer is carried out in the photoelectric transfer layer to generate electrons and positive holes being carriers. Then, the electrons and positive holes are guided by an integrated field into different electrode films, respectively, to output electric energy to the outside.

As a dye sensitizing solar battery which is an organic solar battery, a structure shown in FIG. 10 has been proposed in order to increase the receiving efficiency and utilization efficiency of light (see, e.g., Japanese Patent Laid-Open No. 2002-260746). In a dye sensitizing solar battery 100 shown in FIG. 10, a substrate on a light incident side is a transparent substrate 101, and the light receiving surface of the transparent substrate 101 has a plurality of convex portions 102 like convex lenses. In this solar battery 100, the reverse of the transparent substrate 101 is an irregular surface 103. On the irregular surface 103, a comb electrode 104 serving as a collecting electrode, a semiconductor electrode 105, an electrolyte 106 and a counter electrode 107 are sequentially stacked. A region of the convex portions 102, in which the comb electrode 104 having a shading property is not formed, is designed to be selectively irradiated with incident light. In the dye sensitizing solar battery 100, the angle of incidence of light incident on the light receiving surface of the semiconductor electrode 105 is set to be in the range of from 30° to 80°.

However, in the above described dye sensitizing solar battery 100 shown in FIG. 10, part of light having been incident on the semiconductor electrode 105 passes through the semiconductor electrode 105 without being photoelectrically transferred, so that the utilization efficiency of light is low. If the thickness of the semiconductor electrode 105 increases, most of light can contribute to photoelectric transfer, but there is a problem in that the probability that generated carriers are recombined in the semiconductor electrode 105 to disappear is increased. If the thickness of the semiconductor electrode 105 thus exceeds a predetermined thickness, there is a problem in that the photoelectric transfer efficiency deteriorates. Such problems are conspicuously caused in amorphous silicon solar batteries and wet solar batteries, such as dye sensitizing solar batteries.

In the dye sensitizing solar battery 100 shown in FIG. 10, the angle of incidence of light incident on the light receiving surface of the semiconductor electrode 105 is set to be in the range of from 30° to 80°. However, the convex portions 102 formed on the transparent substrate 101 are intended to cause incident light to enter the region in which the comb electrode 104 is not formed. Between the convex portions 102 and the irregular surface 103 formed on the reverse, incident light is only caused to obliquely enter the solar battery 100, so that the utilization efficiency of light remains being low.

### SUMMARY OF THE INVENTION

It is therefore an object of the present invention to eliminate the aforementioned problems and to provide a solar battery having a high utilization efficiency of light and a high photoelectric transfer efficiency.

It is another object of the present invention to provide a substrate for a solar battery, which can improve the utilization efficiency of light in the solar battery and which can improve the photoelectric transfer efficiency of the solar battery.

In order to accomplish the aforementioned and other objects, according to one aspect of the present invention, a substrate for a solar battery, comprises: a substrate body extending along a plane; a plurality of inclined surfaces, formed on one side of the substrate body so as to be inclined with respect to the plane, for allowing a photoelectric transfer layer to be formed thereon so that the photoelectric transfer layer extends along the plurality of inclined surfaces; a plurality of optical path changing surfaces, each of which is formed on the other side of the substrate body for receiving light beams to change traveling directions of the received light beams toward one end portion of a corresponding one of the plurality of inclined surfaces, the one end portion thereof being arranged on the inside in a direction perpendicular to the plane, wherein each of the plurality of optical path changing surfaces allows at least part of the received light beams to be condensed on a surface of a portion of the photoelectric transfer layer facing the one end portion of the corresponding one of the plurality of inclined surfaces so as to travel in the photoelectric transfer layer.

In this substrate, each of the plurality of optical path changing surfaces may be a surface of a lens unit for focusing on the photoelectric transfer layer. At least part of the plurality of inclined surfaces may be connected so as to form at least one groove.

According to another aspect of the present invention, a solar battery comprises: the above described substrate; and a photoelectric transfer layer formed on the plurality of inclined surfaces. This solar battery may further comprise a collecting electrode arranged between adjacent two of the plurality of inclined surfaces.

### BRIEF DESCRIPTION OF THE DRAWINGS

The present invention will be understood more fully from the detailed description given herebelow and from the accompanying drawings of the preferred embodiments of the invention. However, the drawings are not intended to imply limitation of the invention to a specific embodiment, but are for explanation and understanding only.

In the drawings:

FIG. 1 is a sectional view of a principal part of the first preferred embodiment of a solar battery according to the present invention;

FIG. 2 is an exploded perspective view of the solar battery in the first preferred embodiment;

FIG. 3 is a sectional view of a principal part of a substrate for use in the solar battery in the first preferred embodiment;

FIG. 4 is a sectional view of a principal part of a first modified example of the solar battery in the first preferred embodiment;

FIG. 5 is a sectional view of a principal part of a second modified example of the solar battery in the first preferred embodiment;

FIG. 6 is a sectional view of a principal part of a third modified example of the solar battery in the first preferred embodiment;

FIG. 7 is a sectional view of a principal part of a fourth preferred embodiment of the solar battery in the first preferred embodiment;

FIG. 8 is a sectional view of a principal part of the second preferred embodiment of a solar battery according to the present invention;

FIG. 9 is a sectional view of a principal part of the third preferred embodiment of a solar battery according to the present invention; and

FIG. 10 is a sectional view of a conventional solar battery.

### DESCRIPTION OF THE PREFERRED EMBODIMENTS

Referring now to the accompanying drawings, the preferred embodiments of a solar battery and a substrate for the solar battery according to the present invention will be described below in detail.

[First Preferred Embodiment]

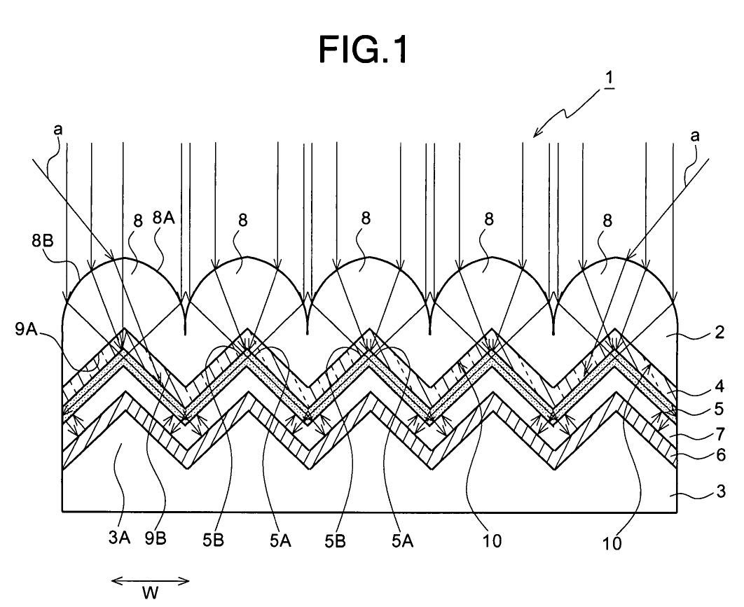

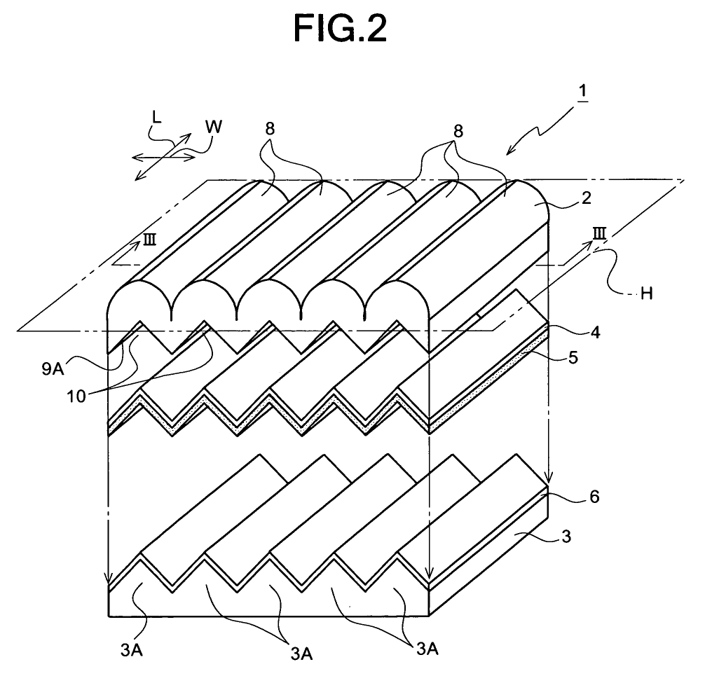

FIGS. 1 through 3 show the first preferred embodiment of a solar battery and a substrate for the solar battery according to the present invention. FIG. 1 is a sectional view of a principal part of the solar battery in the first preferred embodiment, and FIG. 2 is an exploded perspective view of the solar battery.

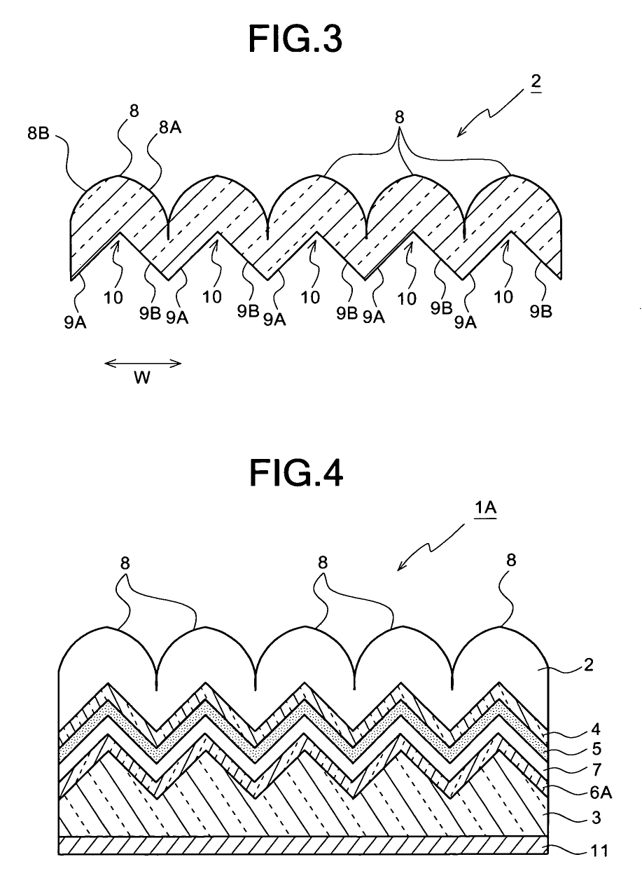

FIG. 3 is a sectional view of a substrate for the solar battery taken along line III-III of FIG. 2.

As shown in FIGS. 1 and 2, the solar battery 1 in this preferred embodiment comprises a substrate 2 for the solar battery, which will be hereinafter referred to as a solar battery substrate, and a counter electrode substrate 3.

On one side of the solar battery substrate 2 facing the counter electrode substrate 3, a transparent electrode 4 and a semiconductor electrode 5 are sequentially stacked. On the surface of the counter electrode substrate 3 facing the solar battery substrate 2, a counter electrode 6 is formed. In the solar battery 1 in this preferred embodiment, the solar battery substrate 2 faces the counter electrode substrate 3 so as to form a narrow gap between the semiconductor electrode 5 and the counter electrode 6. This gap is filled with an electrolytic solution 7 serving as an electrolytic layer. In particular, the one side of the solar battery substrate 2 in this preferred embodiment has a plurality of inclined surfaces which are inclined with respect to a virtual plane. The transparent electrode 4 and the semiconductor element 5 serving as a photoelectric transfer layer are arranged so as to extend along the inclined surfaces. The other side of the solar battery substrate 2 has an optical path changing surface for causing light to enter the inside end face in thickness directions of the photoelectric transfer layer formed on the inclined surfaces. Thus, the structure of the surface of the solar battery substrate 2 is designed to optically correspond to the structure of the reverse thereof.

That is, on the other side of the solar battery substrate 2, the optical path changing surface (lens unit) is formed so as to face the inside end face in thickness directions of the photoelectric transfer layer formed on the inclined surfaces. If the solar battery substrate 2 is macroscopically regarded as a flat plate, the virtual plane means a plane expanding along the surface of the plate. For example, the virtual plane means a plane H shown by a two-dot chain line in FIG. 2.

The solar battery substrate 2 is formed of a transparent resin, and has, e.g., a rectangular planar shape. On one side (surface) of the solar battery substrate 2, a plurality of lens portions (which will be hereinafter referred to as cylindrical lenses) 8, each of which has optical path changing surfaces on both sides, are formed so as to extend in parallel. The cylindrical lenses 8 are arranged closely in lateral directions W and extend in longitudinal directions L as shown in FIG. 2.

As shown in FIG. 3, in the reverse (the other side) of the solar battery substrate 2, V-shaped grooves 10, each of which is defined by a pair of inclined surfaces 9A and 9B, are closely formed. The V-shaped grooves 10 are arranged so as to correspond to the cylindrical lenses 8, respectively, and extend along the cylindrical lenses 8 in parallel to each other.

As shown in FIG. 3, each of the cylindrical lenses 8 comprises a lens surface 8A serving as an optical path changing surface arranged in a direction extending from the inclined surface 9A, and a lens surface 8B serving as an optical path changing surface arranged in a direction extending from the inclined surface 9B. In this preferred embodiment, the inclined surface 9A optically corresponds to the lens surface 8A, and the inclined surface 9B optically corresponds to the lens surface 8B.

The curvature of each of the pair of lens surfaces 8A and 8B forming each of the cylindrical lenses 8 is adjusted so that light beams (incoming beams) incident on the solar battery substrate 2 in a direction substantially perpendicular thereto are condensed on a corresponding one of the end faces (bent portions) of the semiconductor electrode 5, each of the bent portions being arranged (in the vicinity of the valley line) in the valley portion of a corresponding one of the V-shaped grooves 10 (see FIG. 1). That is, light beams incident on the lens surface 8A are designed to be condensed on the end face 5A of the semiconductor electrode 5, the end face 5A being arranged along the inclined surface 9A on the side of the surface of the solar battery substrate 2, and light beams incident on the lens surface 8B are designed to be condensed on the end face 5B of the semiconductor electrode 5, the end face 5B being arranged along the inclined surface 9B on the side of the surface of the solar battery substrate 2.

In this preferred embodiment, the solar battery substrate 2 maybe made of a resin, such as acrylic resin, polyethylene terephthalate (PET) or polycarbonate (PC), or a glass. The solar battery substrate 2 in this preferred embodiment may be molded by a molding method using a die.

On the substantially whole reverse of the solar battery substrate 2 with such a construction, the transparent electrode 4 and the semiconductor electrode 5 are sequentially stacked. The transparent electrode 4 is formed of, e.g., indium-tin oxide (ITO) or tin oxide (SnO₂). The deposition of ITO is carried out by means of, e.g., a sputtering system, using ITO material as a target material in a vacuum chamber and using plasma produced by a high-frequency discharge while a mixed gas of argon (Ar) gas and oxygen gas flows in the system. When the transparent electrode 4 is formed of SnO₂, a glass is preferably used as the material of the solar battery substrate 2. The deposition of SnO₂ is carried out by, e.g., a spray method for spraying a mixed solution of SnCl₄, water and alcohol, which contains a very small amount of NH₄F, onto the reverse of the solar battery substrate 2 heated to 400 to 500° C.

The semiconductor electrode 5 is formed of, e.g., porous titanium dioxide (TiO₂). The semiconductor electrode 5 absorbs and carries a sensitizing dye thereon. The semiconductor electrode 5 may be formed by an electrical deposition method.

The transparent electrode 4 and the semiconductor electrode 5 are formed so as to be bent along the valley lines of the V-shaped grooves 10 of the solar battery substrate 2. As shown in FIG. 1, incident light beams, the optical paths of which are changed on the lens surfaces 8A and 8B of each of the cylindrical lenses 8, are designed to be condensed on the end faces 5A and 5B of the bent portions of the semiconductor electrode 5. Furthermore, as shown by arrow a in FIG. 1, incident light beams deviated from the normal of the solar battery substrate 2 are designed to pass through at least a portion of the semiconductor electrode 5, which is formed along a corresponding one of the inclined surfaces 9B, even if the beams are deviated from the end face 5B of a corresponding one of the bent portions of the semiconductor electrode 5 by a corresponding one of the cylindrical lenses 8 (lens surface 8B). That is, each of the lens surfaces 8A is designed to focus on a portion of the semiconductor electrode 5 formed along a corresponding one of the inclined surfaces 9A, and each of the lens surfaces 8B is designed to focus on a portion of the semiconductor electrode 5 formed along a corresponding one of the inclined surfaces 9B.

Therefore, even if inclined light beams shown by arrow a in FIG. 1 are incident on the solar battery substrate 2 under an indoor illumination such as a fluorescent lamp, the optical paths of incoming light beams passing through each of the lens surfaces 8A and 8B are designed to be changed so that the beams are incident on the semiconductor electrode 5.

The laminated film of the transparent electrode 4 and semiconductor electrode 5 is formed along the inclined surfaces 9A and 9B, which define the V-shaped grooves 10, so as to have a constant thickness. Furthermore, the semiconductor electrode 5 is associated with the electrolytic solution 7 for forming a photoelectric transfer layer.

As shown in FIGS. 1 and 2, the counter electrode substrate 3 in this preferred embodiment is formed of the same material as that of the solar battery substrate 2. On the surface of the counter electrode substrate 3 facing the solar batter substrate 2, protruding portions 3A extending in longitudinal directions are formed in parallel to each other and arranged closely in lateral directions. Each of the protruding portions 3A has such a shape that it can be tightly housed in a corresponding one of the V-shaped grooves 10 formed in the reverse of the solar battery substrate 2.

On the substantially whole surface of the counter electrode substrate 3, the light reflective counter electrode 6 is formed along the surface of the protruding portions 3A.

As shown in FIG. 1, the solar battery substrate 2 and the counter electrode substrate 3 are arranged so as to face each other while defining a constant gap between the semiconductor electrode 5, which is formed on the solar battery substrate 2, and the counter electrode 6 which is formed on the counter electrode substrate 3. This gap is filled with the electrolytic solution 7. Furthermore, the solar battery 1 has a spacer (not shown) for uniformly holding the gap between the solar battery substrate 2 and the counter electrode substrate 3. Around the solar battery substrate 2 and the counter electrode substrate 3, a sealing member (not shown) is provided so as to surround the gap.

In the solar battery 1 in this preferred embodiment, each of the cylindrical lenses 8 having the lens surfaces 8A and 8B serving as the optical path changing surfaces is formed on the surface of the solar battery substrate 2 so as to correspond to the corresponding one of the V-shaped grooves 10 to cause light beams to be incident on the end faces 5A and 5B of the corresponding one of the bent portions of the semiconductor electrode 5 formed on the reverse of the solar battery substrate 2, so that incident light beams are guided in a direction in which the semiconductor electrode 5 extends (in a direction perpendicular to the thickness directions of the semiconductor electrode 5). That is, it is possible to increase the distance by which incident light beams passing through the cylindrical lens 8 enter the semiconductor electrode 5 to travel in the semiconductor electrode 5. Therefore, it is possible to increase the photoelectric transfer quantity in the semiconductor electrode 5. It is thus possible to increase the distance by which incident light beams travel in the semiconductor electrode 5, so that it is possible to decrease the thickness of the semiconductor electrode 5 to such an extent that the recombination of carriers does not occur. Thus, it is possible to provide a solar battery 1 capable of improving the functions of absorbing light and separating carries.

If sunlight is incident on such a solar battery 1 from the outside, the sensitizing dye absorbed and carried on the semiconductor electrode 5 is excited to the excited state from the electronic ground state. The electrons of the excited sensitizing dye are injected into the conduction band of TiO₂ forming the semiconductor electrode 5, to pass through an external circuit (not shown) to the counter electrode 6. The electrons moving to the counter electrode 6 are carried on ions in the electrolytic solution 7 to return to the sensitizing dye. Such an operation is repeated to extract electric energy. In this preferred embodiment, the explanation of the external circuit is omitted.

In the solar battery 1 in this preferred embodiment, the cylindrical lenses 8 are designed to change the optical paths of incident light beams so that the incident light beams enter the end faces 5A and 5B of the bent portions of the semiconductor electrode 5, and to change the optical paths of incident light beams, which are greatly deviated from the normal of the solar battery substrate 2, so that the incident light beams obliquely enter the semiconductor electrode 5. Thus, it is possible to increase the utilization efficiency of light, so that it is possible to greatly improve the photoelectric transfer efficiency.

That is, if at least part of incident light beams passing through the lens surfaces 8A and 8B are designed to enter the end faces 5A and 5B of the semiconductor electrode 5 to travel in the semiconductor electrode 5, it is possible to improve the photoelectric transfer efficiency by the at least part.

In the solar battery 1 in this preferred embodiment, the counter electrode 6 is light-reflective, and light beams passing through the semiconductor electrode 5 are reflected on the counter electrode 6 to enter the semiconductor electrode 5 again, so that it is possible to further improve the photoelectric transfer efficiency.

FIG. 4 shows a first modified example of the first preferred embodiment of a solar battery according to the present invention. FIG. 4 is a sectional view of a principal part of a solar battery 1A taken in lateral directions W.

In the solar battery 1A in the first modified example, the counter electrode 6 of a metal of the solar battery 1 in the first preferred embodiment is replaced with a counter electrode 6A of a transparent material, such as ITO or SnO₂, and a light reflective metal layer 11 is formed on the reverse of the light transmittable counter electrode substrate 3. Since other constructions of the solar battery 1A in the first modified example are the same as those of the solar battery 1 in the first preferred embodiment, the explanation thereof is omitted.

In this solar battery 1A, the counter electrode 6A is made of a chemically stable material, such as ITO, so that there is an advantage in that it is difficult for the electrolytic solution 7 to corrode the counter electrode 6A. Since other operations and effects in the first modified example are the same as those in the first preferred embodiment, the explanation thereof is omitted.

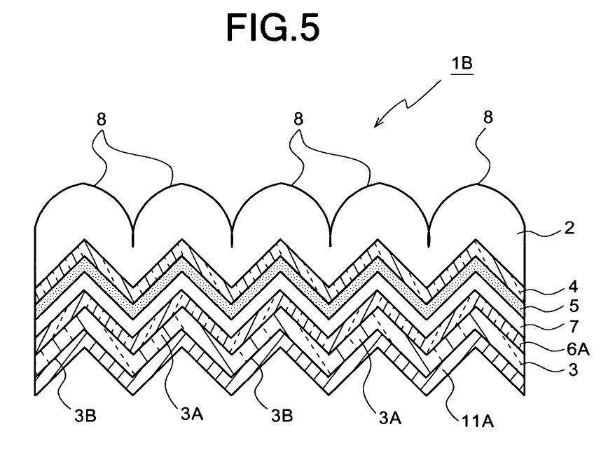

FIG. 5 shows a second modified example of the first preferred embodiment of a solar battery according to the present invention. As shown in FIG. 5, the solar battery 1B in the second modified example has groove portions 3B which are formed in the reverse of the counter electrode substrate 3 so as to correspond to the protruding portions 3A on the side of the surface thereof. The groove portions 3B extend in longitudinal directions in parallel to each other and are arranged closely in lateral directions. A transparent counter electrode 6A is formed on the surface of the counter electrode substrate 3, and a light reflective metal layer 11A is formed on the reverse of the counter electrode substrate 3. Since other constructions in the second modified example are the same as those in the first preferred embodiment, the explanation thereof is omitted.

In the second modified example, the counter electrode 6A may be made of ITO, so that it is possible to enhance the stability of the counter electrode 6A. The metal electrode 11A can cause light beams passing through the semiconductor electrode 5 to enter the semiconductor electrode 5 again, so that it is possible to improve the photoelectric transfer efficiency. Furthermore, other operations and effects in the second modified example are the same as those in the first preferred embodiment.

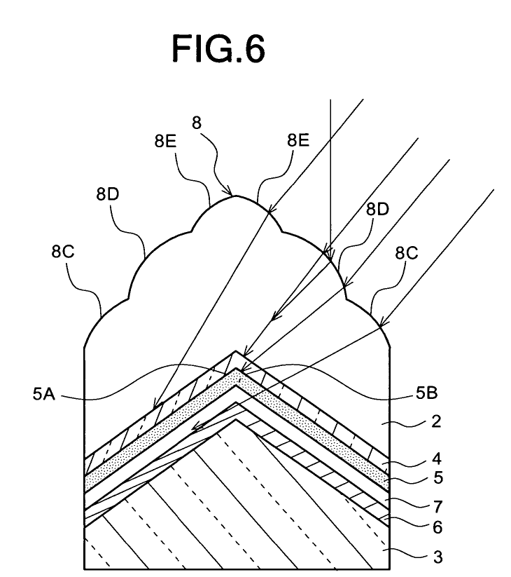

FIG. 6 is a sectional view of a principal part in a third modified example of the first preferred embodiment of a solar battery according to the present invention, which shows only one lens portion. In this modified example, as shown in FIG. 6, cylindrical lenses 8, each of which has a multi-curved surface formed by continuously connecting a plurality of curved surfaces, are substituted for the cylindrical lenses of the solar battery 1 in the first preferred embodiment. That is, each of the cylindrical lenses 8 in this modified example has a plurality of lens units 8C, 8D and 8E on both sides, each of the lens units 8C, 8D and 8E focusing on the photoelectric transfer layer (semiconductor electrode 5). Since other constructions in the third modified example are the same as those in the first preferred embodiment, the explanation thereof is omitted.

In the third modified example, as shown in FIG. 6, each of the cylindrical lenses 8 is formed by the plurality of lens units 8C, 8D and 8E, so that light beams incident on the solar battery substrate 2 in directions inclined from the semiconductor electrode 5 can be condensed on the end faces 5A and 5B of a corresponding one of the bent portions of the semiconductor electrode 5 to focus on the semiconductor electrode 5.

For example, the lens unit 8E is designed to mainly change the optical paths of light beams, which are incident thereon in inclined directions, and the lens unit 8E is designed to mainly change the optical paths of light beams which are incident thereon in the normal direction. Thus, the role of each lens unit can be assigned in view of the use environment of the solar battery and so forth.

Therefore, in the third modified example, incident light beams in various directions are designed to be condensed on the semiconductor electrode 5, so that it is possible to enhance the utilization efficiency of light and the photoelectric transfer efficiency.

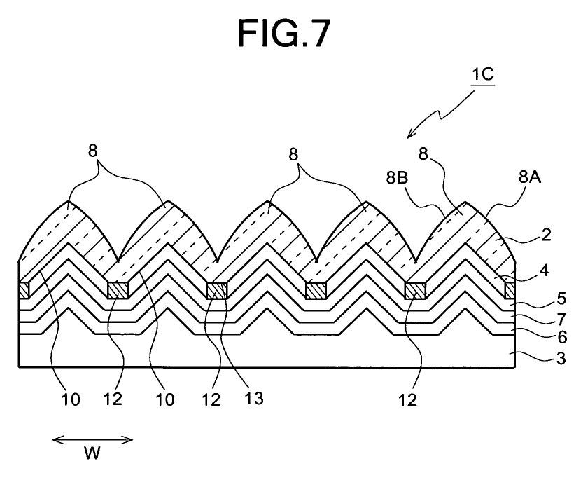

FIG. 7 shows a fourth modified example of the first preferred embodiment of a solar battery according to the present invention. FIG. 7 is a sectional view of the solar battery taken in lateral directions W.

While the transparent electrode 4 in the first preferred embodiment has been formed on the substantially whole reverse of the solar battery substrate 2, the solar battery 1C in the fourth modified example does not have the transparent electrode 4 on the boundary portion between adjacent two of the V-shaped grooves 10 formed in the solar battery substrate 2, and a metal pattern electrode 12 having a low electrical resistance is formed on the boundary portion between adjacent two of the V-shaped grooves 10. As shown in FIG. 7, a flat face 13 is formed in the boundary portion between adjacent two of the V-shaped grooves 10 formed in the solar battery substrate 2. The flat face 13 is arranged in each bottom portion protruding on the side of the reverse of the solar battery substrate 2. On each of the flat faces 13, a metal pattern electrode 12 is formed. Therefore, the transparent electrodes 4 formed on the inner walls of the V-shaped grooves 10 are continuously connected to each other by means of the metal pattern electrodes 12 which are formed on the flat faces 13 at intervals and which extend in parallel to each other. Furthermore, other constructions in the fourth modified example are the same as those in the first preferred embodiment.

In the fourth modified example, it is possible to totally lower the electrical resistance by providing the metal pattern electrode 12 between adjacent two of the transparent electrodes 4 having a high electrical resistance. Even if the metal pattern electrode 12 is thus provided between adjacent two of the transparent electrodes 4, it is possible to greatly decrease the utilization efficiency of incident light beams since most of the incident light beams have been absorbed into the end faces of the bent portions of the semiconductor electrode 5 and the inclined surfaces thereof.

[Second Preferred Embodiment]

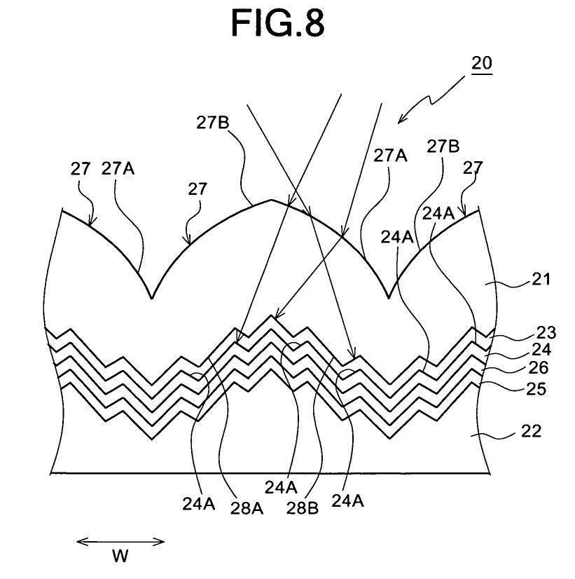

FIG. 8 is a sectional view of a principal part of the second preferred embodiment of a solar battery according to the present invention.

The solar battery 20 in this preferred embodiment comprises a solar battery substrate 21 and a counter electrode substrate 22. In this preferred embodiment, a plurality of inclined surfaces connected to each other with differences in level are formed on the reverse of the solar battery substrate 21.

On the reverse of the solar battery substrate 21, a transparent electrode 23 and a semiconductor electrode 24 are sequentially stacked. On the surface of the counter electrode substrate 22, a counter electrode 25 is formed. In the solar battery 20 in this preferred embodiment, the solar battery substrate 21 faces the counter electrode substrate 22 so as to form a narrow gap between the semiconductor electrode 24 and the counter electrode 25. This gap is filled with an electrolytic solution 26 serving as an electrolytic layer. In particular, although the structure of the surface of the solar battery substrate 21 in this preferred embodiment is designed to optically correspond to the structure of the reverse thereof, the reverse has a finer structure than that of the surface.

The solar battery substrate 21 is formed of a transparent resin, and has, e.g., a rectangular planar shape. On the surface of the solar battery substrate 21, a plurality of cylindrical lenses 27, each of which has a pair of lens surfaces 27A and 28B serving as optical path changing surfaces, are formed so as to extend in parallel. Furthermore, the cylindrical lenses 27 extend in longitudinal directions, and are arranged closely in lateral directions W as shown in FIG. 8.

As shown in FIG. 8, in the reverse of the solar battery substrate 21, a pair of multi-step surfaces 28A and 28B, which are inclined in multi-step, are formed so as to extend along a corresponding one of the cylindrical lenses 27 to form a substantially V-shaped groove as a whole.

The curvature of each of the pair of lens surfaces 27A and 27B of each of the cylindrical lenses 27 is adjusted so that the optical paths of incident light beams are changed toward a plurality of end portions (bent portions) of the semiconductor electrode 24.

Also in this preferred embodiment, the solar battery substrate 21 may be made of a resin, such as acrylic resin, polyethylene terephthalate (PET) or polycarbonate (PC), or a glass. The solar battery substrate 21 in this preferred embodiment may be molded by a molding method using a die.

On the substantially whole reverse of the solar battery substrate 21 with such a construction, the transparent electrode 23 and the semiconductor electrode 24 are sequentially stacked. The transparent electrode 23 is formed of, e.g., ITO. The semiconductor electrode 24 is formed of, e.g., porous titanium dioxide (TiO₂). The semiconductor electrode 24 absorbs and carries a sensitizing dye thereon. Furthermore, the semiconductor electrode 24 is associated with the electrolytic solution 26 for forming a photoelectric transfer layer.

The transparent electrode 23 and the semiconductor electrode 24 are formed so as to follow the bent reverse of the solar battery substrate 21. As shown in FIG. 8, any one of incident light beams, the optical paths of which are changed on each of the cylindrical lenses 27, is designed to enter a corresponding one of the end faces 24A of the bent portions of the semiconductor electrode 24. That is, since the semiconductor electrode 24 is formed in multi-step, light beams directed by each of the cylindrical lenses 27 are easily incident on a corresponding one of the end faces 24A of the bent portions. When light beams thus enter the end faces 24A of the bent portions of the semiconductor electrode 24, the incident light beams pass through the semiconductor electrode 24 by a long distance, so that it is possible to improve the photoelectric transfer efficiency.

As shown in FIG. 8, the counter electrode substrate 22 in this preferred embodiment may be formed of the same material as that of the solar battery substrate 21. The surface of the counter electrode substrate 22 facing the solar battery substrate 21 is formed in multi-step so as to correspond to the irregular structure of the reverse of the solar battery substrate 21. On the substantially whole surface of the counter electrode substrate 22, the light reflective counter electrode 25 is formed along such a multi-step surface.

As shown in FIG. 8, the solar battery substrate 21 and the counter electrode substrate 22 are arranged so as to face each other while defining a constant gap between the semiconductor electrode 24, which is formed on the solar battery substrate 21, and the counter electrode 25 which is formed on the counter electrode substrate 22. This gap is filled with the electrolytic solution 26. Furthermore, the solar battery 20 has a spacer (not shown) for uniformly holding the gap between the solar battery substrate 21 and the counter electrode substrate 22. Around the solar battery substrate 21 and the counter electrode substrate 22, a sealing member (not shown) is provided so as to surround the gap.

In the solar battery 20 in this preferred embodiment, since each of the cylindrical lenses 27 is formed on the surface of the solar battery substrate 21 so that light beams are incident on the large number of end faces 24A of the bent portions of the semiconductor electrode 24 formed on the reverse of the solar battery substrate 21, incident light beams are guided in a direction in which the semiconductor electrode 24 extends (in a direction perpendicular to the thickness directions of the semiconductor electrode 24). That is, incident light beams passing through the cylindrical lenses 27 can enter the semiconductor electrode 24 to travel in the semiconductor electrode 24 by a longer distance. Therefore, it is possible to increase the photoelectric transfer quantity in the semiconductor electrode 24.

In the solar battery 20 in this preferred embodiment, the counter electrode 25 is light-reflective, and light beams passing through the semiconductor electrode 24 are reflected on the counter electrode 25 to enter the semiconductor electrode 24 again, so that it is possible to further improve the photoelectric transfer efficiency.

[Third Preferred Embodiment]

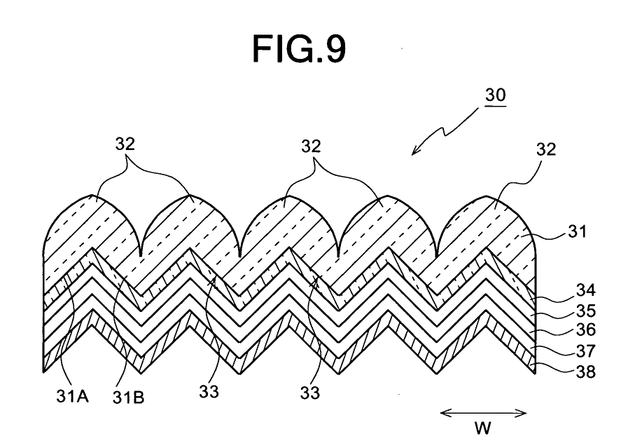

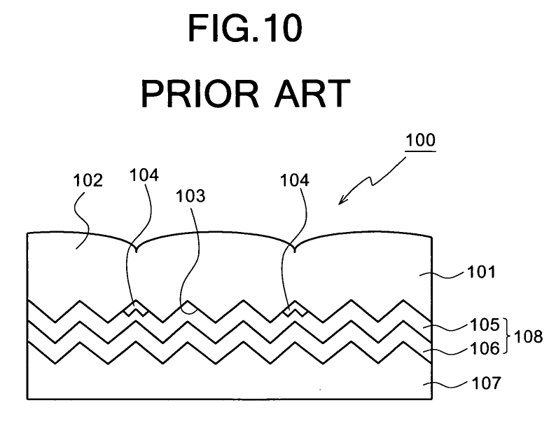

FIG. 9 is a sectional view of a principal part of the third preferred embodiment of a solar battery according to the present invention. The solar battery 30 in this preferred embodiment is an example of a so-called silicon solar battery wherein a photoelectric transfer layer is made of amorphous silicon.

As shown in FIG. 9, the solar battery 30 in this preferred embodiment has a solar battery substrate 31 having the same construction as that of the solar battery substrate 2 of the solar battery 1 in the first preferred embodiment. That is, the solar battery substrate 31 is formed of a transparent resin, and has, e.g., a rectangular planar shape. On the surface of the solar battery substrate 31, a plurality of cylindrical lenses 32 serving as lens portions are formed so as to extend in parallel. Furthermore, the cylindrical lenses 32 extend in longitudinal directions, and are arranged closely in lateral directions W as shown in FIG. 9.

In the reverse of the solar battery substrate 31, V-shaped grooves 33, each of which is defined by a pair of inclined surfaces 31A and 31B, are closely formed so as to extend in parallel. The V-shaped grooves 33 are arranged so as to correspond to the cylindrical lenses 32, respectively, and extend along the cylindrical lenses 32, respectively.

On the substantially whole reverse of the solar battery substrate 31 with such a construction, a transparent electrode 34, an n-type amorphous silicon layer 35 serving as a first conductive-type semiconductor layer, an i-type amorphous silicon layer 36 serving as an intrinsic semiconductor layer, a p-type amorphous silicon layer 37 serving as a second conductive-type semiconductor layer, and a metal electrode 38 are sequentially stacked.

Furthermore, the transparent electrode 34 is formed of, e.g., indium-tin oxide (ITO).

The three layers of n-type amorphous silicon layer 35, i-type amorphous silicon layer 36 and p-type amorphous silicon layer 37, which serve as photoelectric transfer layers, are formed by the plasma CVD method which is a method for depositing an amorphous silicon film. Furthermore-, in the plasma CVD method, silane gas is fed into a vacuum chamber, and a high-frequency voltage is applied thereto, so that silane gas is decomposed to be deposited on the reverse of the solar battery substrate 31. More specifically, in order to form an n-type amorphous silicon layer 35, a very small amount of phosphine gas may be added to silane gas to carry out the plasma CVD method. In order to deposit a p-type amorphous silicon layer 37, diborane gas may be added to silane gas to carry out the plasma CVD method.

In the solar battery 30 in the third preferred embodiment, the three layers of n-type amorphous silicon layer 35, i-type amorphous silicon layer 36 and p-type amorphous silicon layer 37 serving as the photoelectric transfer layers are formed so as to be bent along the V-shaped grooves 33 of the solar battery substrate 31, so that incident light beams, the optical paths of which are changed by the cylindrical lenses 32, are designed to be condensed on the end faces of the bent portions of the photoelectric transfer layers. Furthermore, incident light beams deviated from the normal of the solar battery substrate 31 are designed to be obliquely incident on at least any region on both sides of the bent portions even if the beams are deviated from the end faces of the bent portions of the three photoelectric transfer layers by the cylindrical lenses 32.

In the solar battery 30 in this preferred embodiment, the optical paths of light beams incident on each of the cylindrical lenses 32 are changed, so that the light beams enter the photoelectric transfer layers, particularly the end face of a corresponding one of the bent portions of the i-type amorphous silicon layer 36 in a direction parallel to the layer, i.e., in a direction perpendicular to the thickness directions of the layer. Thus, electrons and positive holes are produced in the i-type amorphous silicon layer 36, and these carriers are separately fed to the transparent electrode 34 and the metal electrode 38 by the integrated field, so that photoelectric transfer is carried out. Also in this preferred embodiment similar to the first preferred embodiment, it is possible to increase the distance by which light beams travel in the i-type amorphous silicon layer 36, so that it is possible to improve the photoelectric transfer efficiency.

Also in this preferred embodiment, the metal electrode 38 is light-reflective, and light beams passing through the i-type amorphous silicon layer 36 can be reflected to enter the i-type amorphous silicon layer 36 again, so that it is possible to further improve the photoelectric transfer efficiency.

While the solar battery 30 in the third preferred embodiment has been provided with no counter electrode substrate, it may have a counter electrode substrate.

The solar battery in the third preferred embodiment may have any one of various structures of the solar battery substrates in the first and second preferred embodiments and the modified examples thereof.

[Other Preferred Embodiments]

While the lens portion formed on the surface of the solar battery substrate in the first through third preferred embodiment has been the cylindrical lens, a convex lens having a spherical surface, or a multi-curved surface lens having a plurality of continuous curved surfaces may be used according to the present invention. The solar battery substrate may have any one of various lens structures, such as prism-shaped and pyramidal structures, as the lens portion or the optical path changing portion.

While the present invention has been applied to the dye sensitizing solar battery and the silicon solar battery having the photoelectric transfer layer of amorphous silicon layer in the first through third preferred embodiments, the invention may be applied to other various solar batteries.

While the semiconductor electrode has been provided on the solar battery substrate in the first and second preferred embodiments, it may be provided on the counter electrode substrate.

In the first through third preferred embodiments, the sectional shape of the cylindrical lens may be a semicircle (a spherical lens) as well as a well-known a non-semicircle (a so-called aspheric surface lens of the second order), such as a semi-elliptical (an ellipsoidal lens) or parabola (a parabolic lens). Moreover, the cylindrical lens may have an aspheric surface of a higher order than the second order.

In the solar battery according to the present invention, the focal point of the lens portion is dislocated in accordance with the wavelength of incident light. However, in the dye sensitizing solar battery in the first and second preferred embodiments, the color of the sensitizing dye to be absorbed and carried on the semiconductor electrode may vary in accordance with wavelength.

As described above, according to the present invention, it is possible to provide a solar battery having a high utilization efficiency of light and a high photoelectric efficiency. In addition, according to the present invention, it is possible to provide a solar battery substrate capable of improving the utilization efficiency of light and the photoelectric transfer efficiency.

Moreover, according to the present invention, it is possible to increase the distance by which incident light beams travel in the photoelectric transfer layer, so that it is possible to decrease the thickness of the photoelectric transfer layer to such an extent that the recombination of carriers does not occur. Thus, it is possible to provide a solar battery capable of improving the functions of absorbing light and separating carries.

While the present invention has been disclosed in terms of the preferred embodiment in order to facilitate better understanding thereof, it should be appreciated that the invention can be embodied in various ways without departing from the principle of the invention. Therefore, the invention should be understood to include all possible embodiments and modification to the shown embodiments which can be embodied without departing from the principle of the invention as set forth in the appended claims.

1. A substrate for a solar battery, said substrate comprising:
a substrate body extending along a plane;
a plurality of inclined surfaces, formed on one side of said substrate body so as to be inclined with respect to said plane, for allowing a photoelectric transfer layer to be formed thereon so that the photoelectric transfer layer extends along said plurality of inclined surfaces;
a plurality of optical path changing surfaces, each of which is formed on the other side of said substrate body for receiving light beams to change traveling directions of the received light beams toward one end portion of a corresponding one of said plurality of inclined surfaces, said one end portion thereof being arranged on the inside in a direction perpendicular to said plane,
wherein each of said plurality of optical path changing surfaces allows at least part of the received light beams to be condensed on a surface of a portion of said photoelectric transfer layer facing said one end portion of the corresponding one of said plurality of inclined surfaces so as to travel in said photoelectric transfer layer.

2. A substrate for a solar battery as set forth in claim 1, wherein each of said plurality of optical path changing surfaces is a surface of a lens unit for focusing on said photoelectric transfer layer.

3. A substrate for a solar battery as set forth in claim 1, wherein at least part of said plurality of inclined surfaces are connected so as to form at least one groove.

4. A solar battery comprising:
a substrate according to claim 1; and
a photoelectric transfer layer formed on said plurality of inclined surfaces.

5. A solar battery as set forth in claim 4, which further comprises a collecting electrode arranged between adjacent two of said plurality of inclined surfaces.
